(19) United States
(12) Patent Application Publication
(10) Pub. No.: US 2012/0185385 A1
(43) Pub. Date: Jul. 19, 2012

(54) Asset Theft Reporting System

(76) Inventors: Maurizio Scrofani, Riverdale, NJ (US); David John Shillingford, New York, NY (US)

(21) Appl. No.: 13/006,866

(22) Filed: Jan. 14, 2011

(51) Int. Cl. G06Q 40/00; G06K 19/06

(52) U.S. Cl. 705/41; 235/493

(57) ABSTRACT

An asset theft reporting system is provided, and includes a pre-paid debit card provided to an individual which is initially capable of being used only to pay for a telephone call by the individual to report a theft of an asset such as a vehicle. The asset is pre-registered with the system, and information about the asset is stored in a database. A telephone call from the individual reporting a theft of the asset is received and processed, and information about the theft is stored in the database. When the theft has been reported, the pre-paid debit card is electronically configured for use as a general-purpose debit card to purchase goods and/or services. Optionally, the system can contact one or more law enforcement authorities, and/or other entities, to report the theft of the asset and to initiate an investigation.

### BACKGROUND OF THE INVENTION

1. Field of the Invention

The present invention relates generally to the field of crime prevention, and more particularly to an asset theft reporting system.

2. Related Art

Prompt reporting of thefts of assets, such as thefts of vehicles (cars, trucks, etc.) and other property, is critical to possible recovery of such assets by law enforcement authorities. In the case of commercial vehicles (which often include expensive cargo), it is essential that thefts of vehicles be promptly reported so that stolen assets can be quickly identified and investigations can be initiated. This is particularly important in situations where valuable cargo is susceptible to being quickly removed from a vehicle by a criminal, and where the cargo is not uniquely identifiable due to a lack of unique markings.

It is known to reward an individual (e.g., monetarily) for reporting thefts. However, the reward is often not immediately available to the person reporting the theft. An immediate reward could be beneficial in the case of a stolen vehicle, because the owner/operator of the vehicle has no means for transportation and is clearly inconvenienced by the theft. Moreover, a person reporting a theft may require immediate access to money to pay for necessary travel, lodging, telephone calls, etc. It is therefore desirable to provide a system which encourages prompt reporting of thefts of assets, and which also provides immediate monetary compensation to persons reporting such thefts.

### SUMMARY OF THE INVENTION

The present invention relates to an asset theft reporting system. The system includes a pre-paid debit card provided to an individual, which is initially capable of being used only to pay for a telephone call by the individual to report a theft of an asset such as a vehicle. The individual, such as a driver, and associated asset, such as a commercial vehicle, are pre-registered with the system, and information about the individual and the asset is stored in a database. A telephone call from the individual reporting a theft of the asset is received and processed (e.g., at a central call center). Information about the theft (e.g., the approximate date and time of the theft, approximate location of the theft (if known), etc.) is stored in the database. When the theft has been reported, the pre-paid debit card is electronically configured for use as a general-purpose debit card to purchase goods and/or services. Once configured, an account associated with the debit card could be credited with a pre-defined amount of money, for future use in purchasing goods and/or services. Optionally, the system can contact one or more law enforcement authorities and/or other entity to report the theft of the asset, to initiate an investigation, and/or to send theft alerts to a broader network.

The preset invention also provides a method for reporting a theft of an asset. The method includes the steps of electronically storing information about an asset in a database in a computer system, providing a pre-paid debit card to an individual, electronically configuring the pre-paid debit card for use by the individual only to pay for a telephone call, receiving and processing a telephone call from the individual reporting a theft of the asset, and electronically configuring the pre-paid debit card for use as a general-purpose debit card up to a pre-arranged limit to purchase goods and/or services after processing of the telephone call reporting the theft of the asset.

The present invention also provides a debit card for use in reporting a theft of an asset. The card includes a first surface including an account number of a card holder, and a second surface including a magnetically-encoded strip and a telephone number to be dialed by the card holder in the event of a theft of an asset to report said theft to a call center. The debit card is initially configured only for use by the card holder as a pre-paid telephone card, and is subsequently configured for use as a general-purpose debit card after the theft has been successfully reported by the card holder to the call center.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing the asset theft reporting system of the present invention;

FIGS. 2A-2B are front and rear views of a debit card in accordance with the present invention for use in reporting a theft of an asset;

FIG. 3 is a flowchart showing steps according to the present invention for registering an asset and creating a debit card account; and

FIG. 4 is a flowchart showing steps according to the present invention for processing a report of a theft of an asset.

### DETAILED DESCRIPTION OF THE INVENTION

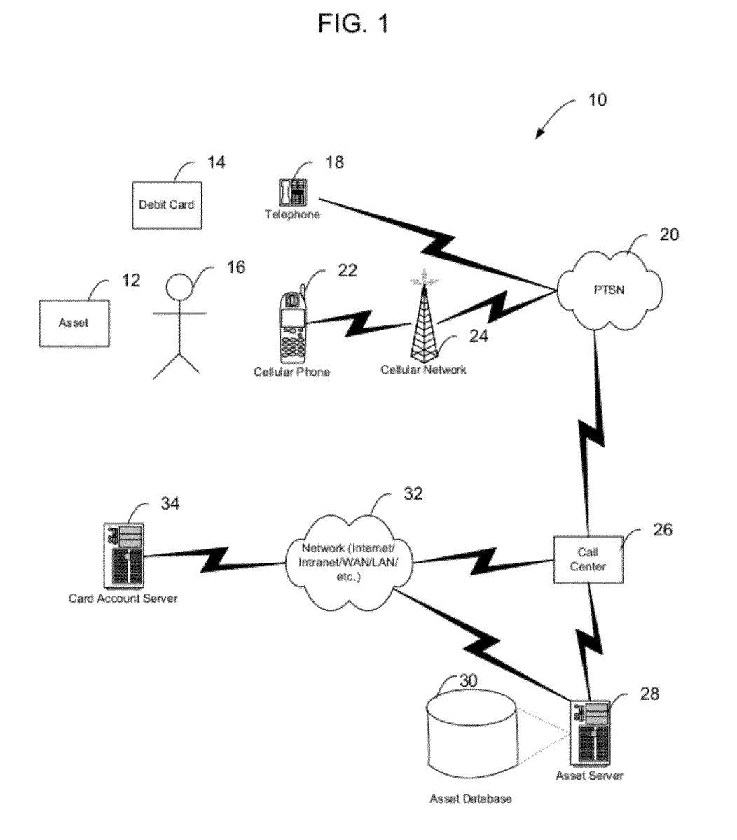

The present invention relates to an asset theft reporting system, as discussed in detail below with reference to FIGS. 1-4.

FIG. 1 is a diagram showing the asset theft reporting system 10 of the present invention. The system 10 allows for registration of an asset 12, such as a vehicle, and for reporting thefts of such assets. The system 10 includes a debit card 14 which is issued to an individual, such as an owner and/or operator 16 of the asset 14 (e.g., an operator of a truck). The card 14 is issued to the owner/operator 16 after the vehicle is registered with an administrator of the system 10. In order to register the asset 12, an owner may provide relevant information about the asset. For example, in the case of a vehicle, the owner can provide information about the vehicle such as the vehicle make, model, vehicle identification number (VIN), license plate number, authorized operators of the vehicle, or other information. The information can be stored in an asset database 30 hosted by one or more computer servers 28. The server 28 could be any suitable computer system operating any suitable operating system, such as a computer system having an Intel microprocessor and running the Microsoft Windows Server operating system, Unix, Linux, etc. Of course, any suitable type of server and associated system software could be utilized. The database 30 could be any suitable type of relational database created and maintained using appropriate relational database management software, such as Oracle, MySQL, etc.

When the asset 12 is registered with the system 10, the debit card 14 is issued to the owner/operator 16 of the asset 12. Initially, the card 14 is electronically configured for use only as a pre-paid telephone card, i.e., the card 14 can only be used to place telephone calls. The card 14 is electronically credited with a pre-defined amount of money determined by an operator of the system 10, for use only in placing telephone calls. An electronic account corresponding to the card 14 is created, associated with the card 14, stored in one or more card account servers 34, and maintained thereon.

In the event of a theft of the asset 12, the owner/operator 16 can use the card 14 to place a phone call to report a theft of the asset to an operator of the system 10, e.g., to a call center 26. Such a call can be placed using a land telephone line 18 (e.g., a public pay phone) in communication with the call center 26 via the public switched telephone network (PTSN) 20, and/or a cellular phone 22 in communication with the call center 26 via a cellular network 24 and the PTSN 20. The call is processed by the call center 26, and the reported theft can be logged (e.g., in the asset database 30). Optionally, one or more law enforcement authorities can be contacted by the call center 26 and the theft reported, so that investigation can be carried out by law enforcement officials. Moreover, a theft alert could also be broadcasted by the system 10 to one or more law enforcement authorities and/or other entities, relating to the theft of the asset.

When the theft report is processed by the call center 26, an account in a card account server 34 corresponding to the card 14 is electronically configured so that the card 14 can be utilized as a general purpose debit card. Also, the account could be credited a pre-defined amount of money (e.g., $100), for use in purchasing any desired good/service, or only selected goods/services. Thus, when the theft has been successfully reported to the call center 26, the card 14 can be used by the owner/operator 16 not only as a telephone card, but also as a general purpose debit card to purchase goods and/or services. This is advantageous in the case of a theft of a vehicle, in which case the card 14 can be used by the owner/operator 16 to pay for necessary transportation, lodging, meals, etc., which may be necessitated as a result of a vehicle theft. As can be appreciated, the card 14 provides an incentive to owners and/or operators of assets to promptly report thefts of such assets.

It is noted that the card account server 34 and the asset server 28 could be in communication via a network 32, such as the Internet, an intranet, wide area network (WAN), local area network (LAN), etc. Also, the call center 26 could be in communication with the asset server 28 and/or the card account server 34. The servers 28 and 34 could be remote from each other, or they could be at the same location. Further, the functions provided by the servers 28 and 34 could be provided by a single server. Still further, the servers 28 and 34 could be secured by associated network hardware and/or software (e.g., firewalls, virtual private network (VPN) connections, encryption software, etc.).

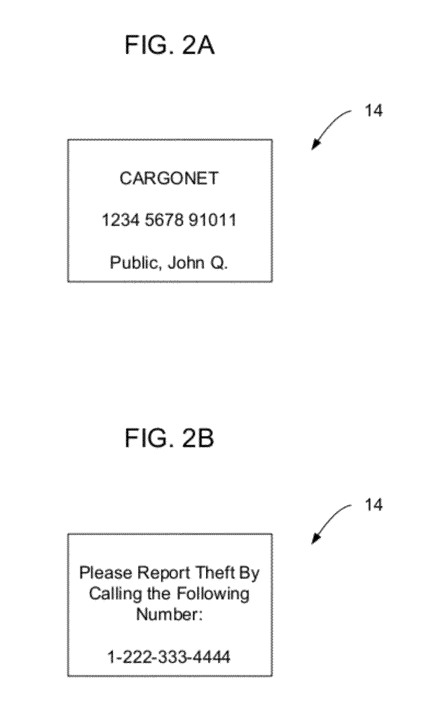

FIGS. 2A-2B are front and rear views, respectively, of the card 14 in greater detail. As mentioned above, the card 14 initially functions only as a phone card which can be used to place a telephone call to the call center 24 of FIG. 1 to report a theft of an asset. As shown in FIG. 2A, the card 14 could include an account number and a name of the card holder. As shown in FIG. 2B, the card 14 could include a telephone number to call to report a theft of an asset, e.g., the telephone number of the call center 24 of FIG. 1. As with known credit/debit cards, the card 14 could also include information encoded therein, such as the account number, card holder name, etc., using an encoded magnetic strip, etc., so that the card 14 can be electronically utilized at a point of sale (e.g., by “swiping” the card through a card reader).

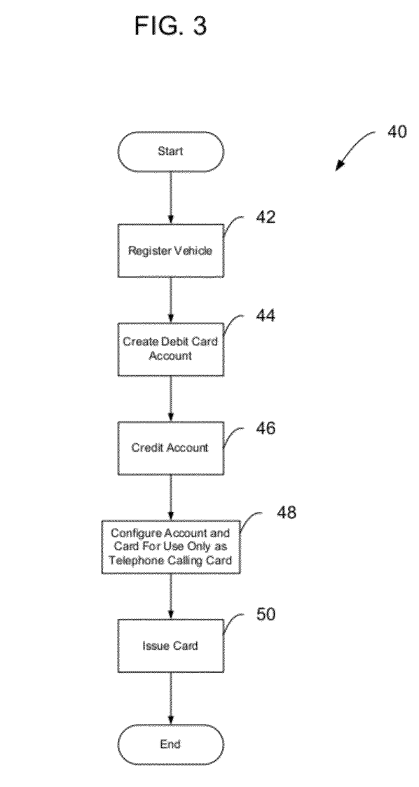

FIG. 3 is a flowchart showing steps 40 for registering an asset with the system and for creating a debit card account for a card holder. Beginning in step 42, an owner or operator of an asset, as well as the asset (e.g., a vehicle), are registered with the system. As mentioned above, the information about the asset could include a VIN number, vehicle make, model number, owner name, etc. This information can be stored in the database 34 of FIG. 1. Once the asset and owner/operator are registered, step 44 occurs, wherein a debit card account is created and associated with the registered asset. The debit card account is also associated with a card holder, e.g., an operator of a vehicle registered with the system. The debit card account could be electronically stored and maintained in the card account server 34 of FIG. 1. In step 46, the account is credited with a predetermined amount of funds. For example, the account could be credited with sufficient funds to allow the cardholder to place a telephone call to report a theft of an asset. In step 48, the account is configured so that the card may only be used as a telephone calling card, so as to prevent usage of the card for other purposes. Then, in step 50, the card is issued to the card holder.

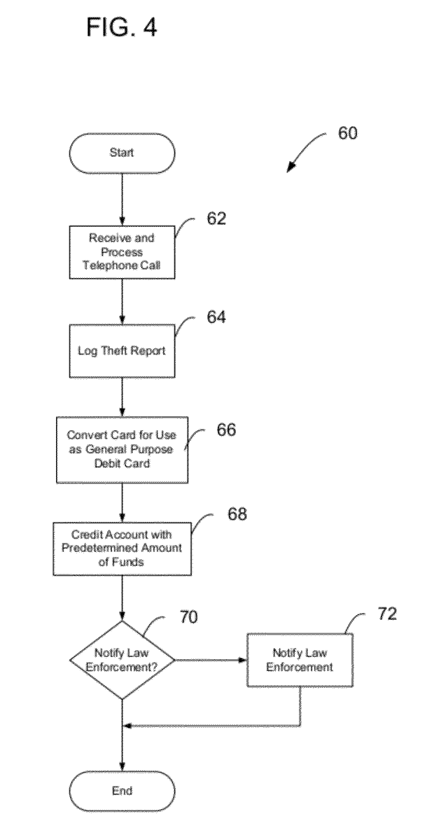

FIG. 4 is a flowchart showing processing steps 60 for processing a report of a theft of an asset. In step 62, a telephone call is received (e.g., at the call center 26 of FIG. 1) and processed. In the call, information about a theft is acquired from the caller, such as the date and time of theft, asset stolen, VIN number (if applicable), license plate number (if applicable), serial number of asset (if applicable and/or known), location of theft (if known by the caller), and/or any other information. In step 64, the acquired information is logged as a theft report, and stored (e.g., in the asset database 30 of FIG. 1). In step 66, the card 14 of FIG. 1 is converted for use as a general-purpose debit card. This can be accomplished by electronically updating the account record corresponding to the card 14 and stored in the card account server 34 of FIG. 1, so that any time that the card 14 is utilized, the card account server 34 permits utilization of the card 14 for purposes in addition to placing a telephone call. For example, if the card 14 is utilized in the future at a point of sale to purchase goods or services, the card account server 34 could be electronically contacted by a terminal at a point-of-sale (e.g., when the card 14 is swiped), and the server 34 could authorize the purchase for the good or service.

In step 68, the card account in the card account server 34 is electronically credited with a predetermined amount of funds, e.g., $100, thereby making additional funds available to the cardholder for use in purchasing goods and/or services. Any desired amount of funds could be credited. In step 70, a determination is made as to whether the theft of the asset should be reported to one or more law enforcement authorities. If so, step 72 occurs, wherein one or more law enforcement authorities are contacted (e.g., by the call center 26) and the theft is reported so that an investigation can be conducted. Advantageously, the information acquired by the system of the present invention (e.g., dates and times of thefts, location information, etc.) can assist law enforcement authorities in conducting investigations into stolen assets. A theft alert may also be broadcast to one or more non-law-enforcement entities to further increase the chances of recovery.

As can be appreciated, the present invention provides a system for encouraging the swift reporting of thefts of assets, and for tracking such assets, by providing individuals with a financial incentive to report thefts in the form of a pre-paid, multi-use debit card. By restricting use of the card prior to a report of a theft as a pre-paid telephone card, the present invention provides sufficient funds to allow a person to place a telephone call to report a theft at no expense to the person. Further, by converting the card to use as a general-purpose debit card and providing additional funds for use in purchasing goods and/or services after a theft has been reported, the present invention “rewards” the reporting of thefts and encourages same. As mentioned above, the present invention can be utilized in connection with any conceivable type of asset, including, but not limited to, vehicles.

It is noted that the present invention could be utilized in connection with one or more Interactive Voice Response (IVR) computer systems to handle telephone calls reporting thefts. In such circumstances, the IVR system could replace and/or supplement the call center 26, and could automatically process calls relating to thefts using voice synthesis and voice recognition technology, as is known in the art. Moreover, such a system could automatically broadcast an alert to a law enforcement agency or other entity, alerting such agency or entity of the theft of an asset. It is also noted that the ability to place funds on the card might also be used for theft prevention activities such as a reward for a driver engaging in a security awareness or training program.

Having thus described the invention in detail, it is to be understood that the foregoing description is not intended to limit the spirit or scope thereof. What is desired to be protected is set forth in the following claims.

What is claimed is:

1. An asset theft reporting system, comprising:
a pre-paid debit card provided to an individual, the pre-paid debit card initially capable of being used only to pay for a telephone call by the individual;
a computer system including a database containing information about an asset;
means for receiving and processing a telephone call from the individual reporting a theft of the asset; and
means for electronically configuring the pre-paid debit card for use as a general-purpose debit card to purchase goods and/or services after processing of the telephone call reporting the theft of the asset.

2. The system of claim 1, wherein the means for receiving and processing the telephone call comprises a call center at which the call is received and processed.

3. The system of claim 1, wherein the means for receiving and processing the telephone call comprises an interactive voice response (IVR) system for receiving and processing the telephone call.

4. The system of claim 1, wherein the computer system stores information about the theft of the asset after the telephone call reporting the theft of the asset has been processed.

5. The system of claim 1, wherein the means for electronically configuring the pre-paid debit card credits an account associated with the pre-paid debit card with a pre-defined amount of funds for use in purchasing goods and/or services after processing of the telephone call reporting the theft of the asset.

6. The system of claim 1, further comprising means for contacting one or more law enforcement authorities to report the theft of the asset.

7. The system of claim 1, further comprising means for transmitting an alert to at least one non-law-enforcement entity relating to the theft of the asset.

8. A method for reporting a theft of an asset, comprising the steps of:
electronically storing information about an asset in a database in a computer system;
electronically configuring a pre-paid debit card for use by an individual only to pay for a telephone call;
providing the pre-paid debit card to the individual;
receiving and processing a telephone call from the individual reporting a theft of the asset; and
electronically configuring the pre-paid debit card for use as a general-purpose debit card to purchase goods and/or services after processing of the telephone call reporting the theft of the asset.

9. The method of claim 8, wherein the step of receiving and processing the telephone call comprises receiving and processing the telephone call at a call center.

10. The method of claim 8, wherein the step of receiving and processing the telephone call comprises receiving and processing the telephone call using an interactive voice response (IVR) system.

11. The method of claim 8, further comprising storing information about the theft of the asset in the database.

12. The method of claim 8, further comprising electronically crediting an account associated with the pre-paid debit card with a pre-defined amount of funds for use in purchasing goods and/or services after processing of the telephone call reporting the theft of the asset.

13. The method of claim 8, further comprising contacting one or more law enforcement authorities to report the theft of the asset.

14. The method of claim 8, further comprising contacting one or more non-law-enforcement entities to report the theft of the asset.

15. A debit card for use in reporting a theft of an asset, comprising:
a first surface including an account number of a card holder; and
a second surface including a magnetically-encoded strip and a telephone number to be dialed by the card holder in the event of a theft of an asset to report said theft to a call center,
wherein the debit card is initially configured only for use by the card holder as a pre-paid telephone card, and wherein the debit card is subsequently configured for use as a general-purpose debit card after the theft has been successfully reported by the card holder to the call center.

16. The debit card of claim 15, wherein an account corresponding to the debit card is credited with a first pre-defined amount of money for use only in placing telephone call.

17. The debit card of claim 16, wherein the account is credited with a second pre-defined amount of money after the theft has been successfully reported by the card holder.
